(19) United States
(12) Patent Application Publication
(10) Pub. No.: US 2010/0100771 A1
(43) Pub. Date: Apr. 22, 2010

(54) SETUP VERIFICATION FOR AN EMPLOYEE COMPENSATION SYSTEM

(75) Inventors: Anadi Upadhyaya, Hyderabad (IN); Ty Hayden, Grand Junction, CO (US); Manish Agrawal, Campbell, CA (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/254,502

(22) Filed: Oct. 20, 2008

(51) Int. Cl. G06F 11/36

(52) U.S. Cl. 714/38; 714/E11.207

(57) ABSTRACT

A compensation system receives a plurality of setup parameters. The compensation system tests the setup parameters through a verification. The verification generates an error output if the setup parameters will lead to undesirable results when operating the compensation system.

### FIELD OF THE INVENTION

One embodiment is directed generally to a computer system, and in particular to an employee compensation computer system.

### BACKGROUND INFORMATION

Managers and compensation professionals use tools to strategically manage compensation at a global level. Compensation can be used to enhance productivity, increase morale, and retain highly valued employees. Compensation tools and systems are available that allow total compensation, including base salaries, bonuses and equity to be efficiently managed and aligned with performance.

Available integrated compensation systems allow managers and compensation professionals to plan, model, and allocate budgets and awards on a global basis across multiple currencies. Users can distribute budgets and compensation based on guidelines and see a worksheet view of employees, their performance ratings and total compensation. They can also promote employees and give them new performance ratings and rankings. Analytics provide internal and external comparisons, statistical analysis, compensation history, and overviews of current budgets and allocations so managers can make decisions that support business objectives.

These complex integrated compensation systems may obtain data through other modules of an integrated application system such as an Enterprise Resource Planning (“ERP”) system. A setup process is typically required before running complex compensation systems.

### SUMMARY OF THE INVENTION

One embodiment is a compensation system that receives a plurality of setup parameters. The compensation system tests the setup parameters through a verification. The verification generates an error output if the setup parameters will lead to undesirable results when operating the compensation system.

### BRIEF DESCRIPTION OF THE DRAWINGS

FIG. 1 is a block diagram of a system that can implement an embodiment of the present invention.

FIG. 2 is a block diagram of setup parameters for a compensation module in accordance to one embodiment.

FIGS. 3a-3c are a flow diagram of the functionality of the compensation module when validating setup parameters for a compensation system in accordance with one embodiment.

FIG. 4 is a user interface for tracking that setup tasks are completed and initiating validation in accordance with one embodiment,

FIG. 5 is a user interface in accordance with one embodiment that allows an administrator to check setup for readiness in response to selecting the verification task of FIG. 4.

FIG. 6 is a user interface in accordance with one embodiment that illustrates a pop up window for verification.

### DETAILED DESCRIPTION

One embodiment is a compensation system that includes a setup process in order to incorporate setup parameters and business rules. The system further includes a setup verifier that checks for errors in the setup process before setup is run and before the system is already in production and used by a large user base. Therefore, errors that impact accuracy and create frustration for the users can be avoided.

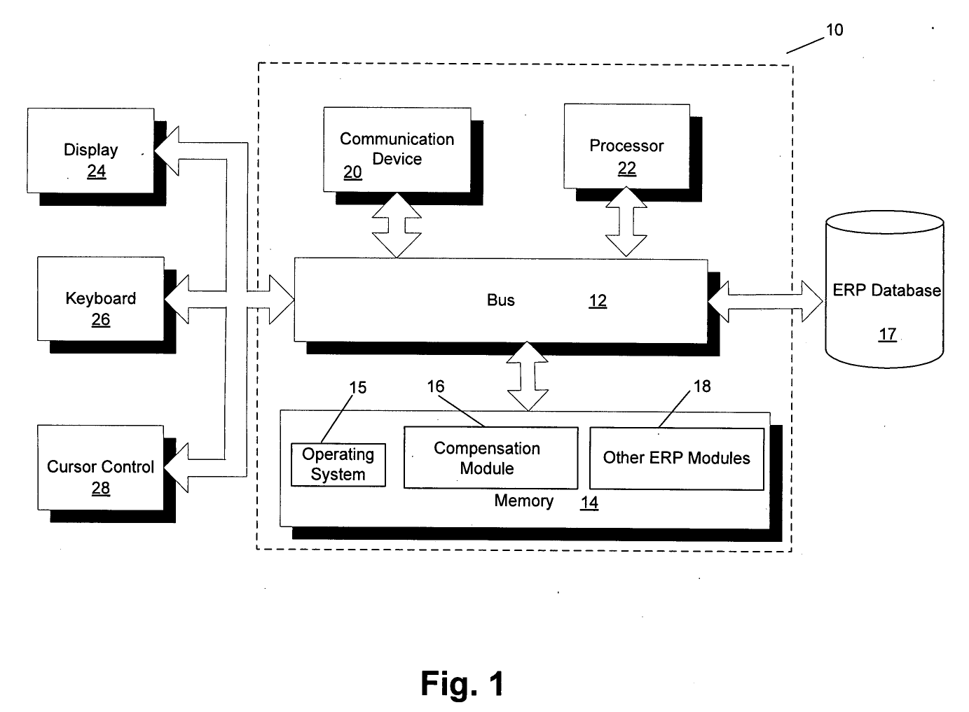

FIG. 1 is a block diagram of a system 10 that can implement an embodiment of the present invention. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a compensation module 16 that performs compensation functions, including a setup verifier, as disclosed in more detail below. The modules further include other enterprise resource planning (“ERP”) modules 18 of an ERP system that may interact with compensation module 16, such as a Human Resources (“HR”) module, which may include a payroll module, a performance management module, a financial module, a procurement module, etc. An ERP system is a computer system that integrates several data sources and processes of an organization into a unified system. A typical ERP system uses multiple components of computer software and hardware to achieve the integration. A unified ERP database 17, coupled to bus 12, is used to store data for the various system modules. In one embodiment, ERP modules 18 are part of the “Oracle E-Business Suite Release 12” ERP system from Oracle Corp. In other embodiments, compensation module 16 may be a stand-alone system and not integrated with an ERP system, or may be part of any other integrated system.

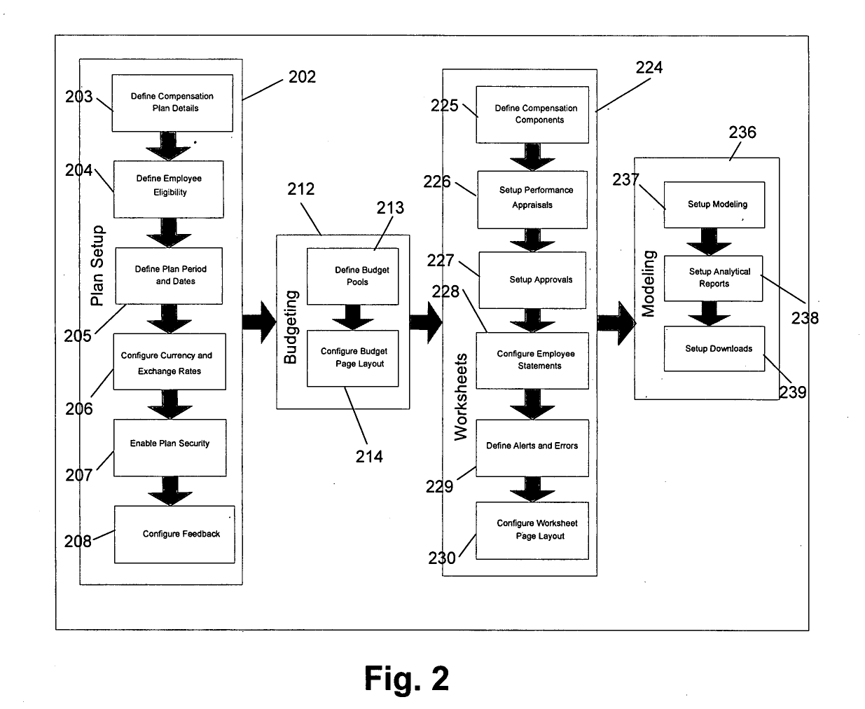

FIG. 2 is a block diagram of setup parameters for compensation module 16 in accordance to one embodiment. In one embodiment, the setup parameters of FIG. 2 are entered before the setup parameters are verified.

Plan setup parameters 202 include defining a compensation plan details/properties 203. 203 in one embodiment provides compensation plan administrators the ability to define the general properties of a compensation plan, including the plan name, plan description, and plan status. Other properties assist with compensation module 16 handling, such as the hierarchy used for approvals and budgets, gap handling measures, multiple assignments handling, and common salary frequency.

Define employee eligibility 204 provides administrators the ability to define participant eligibility profiles to limit the employees who are eligible for the plan. It also provides options for tracking and showing ineligible employees.

Define plan period and dates 205 provides administrators with the ability to define the start and end dates of the plan. Also available to define includes a period name (and display name), freeze dates, self-service availability dates, change dates, and conversion rate effective dates.

Configure currency and exchange rates 206 provides administrators with the ability to define the default corporate currency, currency switching capabilities, and system rules for conversion or missing rate error handling.

Enable plan security 207 provides administrators with the ability to define the security access type for individual functions or roles within their administrative structure. Examples of access types include Read Only or Full Access.

Configure feedback 208 provides administrators with the ability to create a survey window to capture feedback from managers after submitting a worksheet for approval.

Budgeting setup parameters 212 includes define budget pools 213 that provides administrators with the ability to enable and configure a budget for a plan. A budgeting method is defined along with rules for over-budgeting or over-allocation. A budget pool allows for further granularity of budgeting. Multiple budget pools may be associated with one plan. Budget pools may be grouped to any number of compensation components of a compensation plan.

Configure budget plan layout 214 provides administrators with the ability to configure what data shows on a budget worksheet, the order of the data, available menu actions, and instructions for the manager.

Worksheet setup parameters 224 are parameters for a worksheet. In one embodiment, a worksheet is the area or user interface where a manager would go to award compensation (e.g., salary increases, bonus, stock options, etc) to their employee workforce. Managers with employees reporting directly or indirectly to them who are eligible to receive compensation may have access to a worksheet on which all eligible employees appear. Managers may enter allocation amounts or percentages of eligible salary on this worksheet for all employees who are to receive a compensation award. Define compensation component 225 provides administrators with the ability to mix and match different compensation components to be available under one plan.

Setup performance appraisals 226 provides administrators with the ability to define performance evaluation ratings within database 17 or import performance ratings from another database. Examples of options include use no performance ratings, define own performance ratings, or integrate with an HR talent management module ratings. Configurable parameters can be available if an administrator defines their own performance ratings.

Setup approvals 227 provides administrators with the ability to define the settings for approving, submitting, and intercepting an individual reward allocation worksheet.

Configure employee statements 228 provides administrators the ability to enable employee statement generation and determine under which conditions employees should receive one.

Define alerts and errors 229 provides administrators the ability to centrally define alerts for the system to execute. In one embodiment, a set of standard alerts will be the default choice, but embodiments may include the capability for administrators to define alerts, warnings, errors, and informational notices using their own criteria and text.

Configure worksheet page layout 230 provides administrators with the ability configure a manager self service rewards allocation worksheet. Configurable options may include tab names, number of tabs, menu options, data columns exposed, ordering of data columns, instructions, and copying layout options from another plan.

Modeling setup parameters 236 include setup modeling 237 that provides administrators with the ability to centrally define the properties of the modeling functionality. Modeling properties include permissions for managers, sharing capabilities, available allocation criteria, and usage (for budgets, targets, or actual allocation amounts). Further included is defining which dimensions to provide to managers in the criteria dropdown for building their own methods.

Setup analytical reports 238 provides administrators the ability to determine which of the delivered analytics will be represented to the managers during plan deployment.

Setup downloads 239 provide administrators the ability to setup download definitions for worksheets, budgets, and administration reports.

In one embodiment, administrators/users are able to detect and correct errors prior to deployment once setup parameters have been entered. This allows administrators to test their setup prior to deployment. The validation shows specific errors and warnings regarding the setup for a plan. An “error” indicates a wrong setup that may lead to undesirable results (e.g., participation errors, no employees get processed, data is corrupted or will cause things not to work properly, etc.). A “warning” indicates that something may be wrong, but will not have much effect on performance of the compensation system.

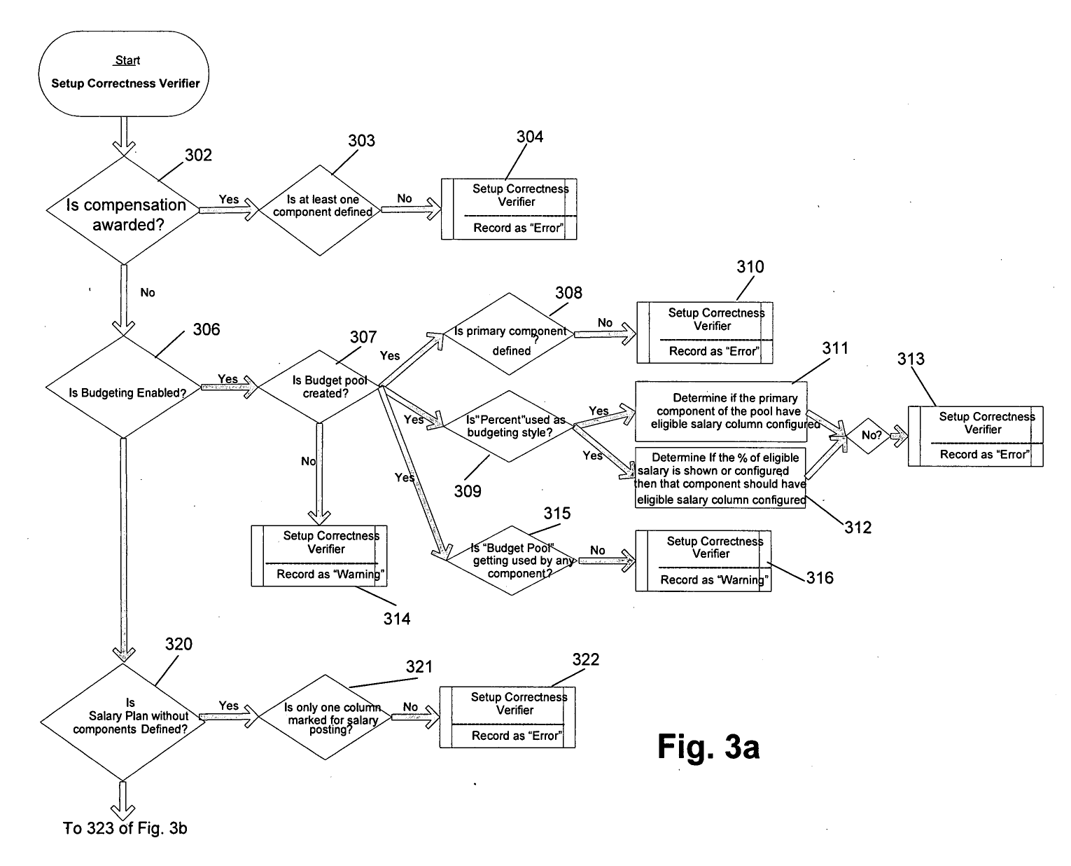

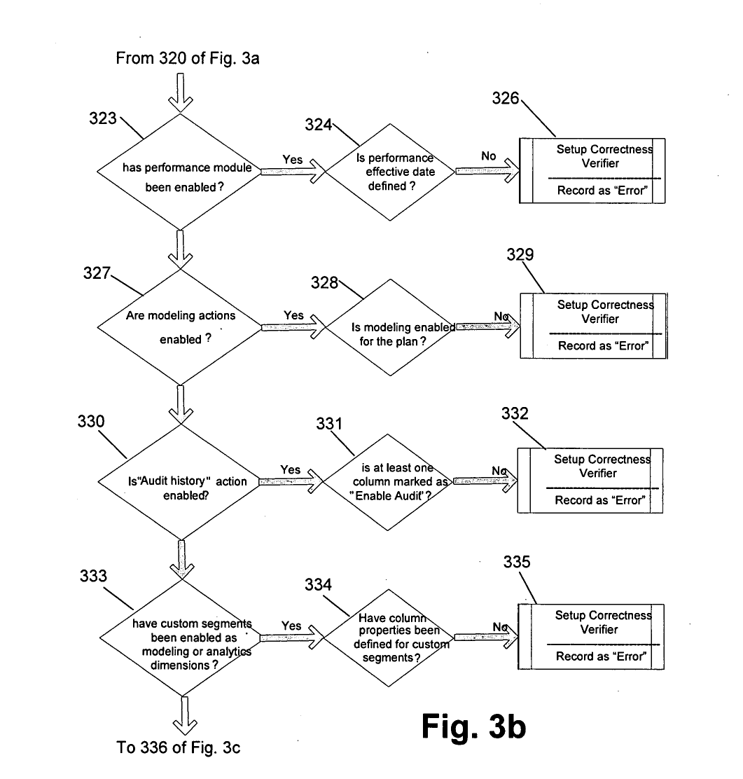

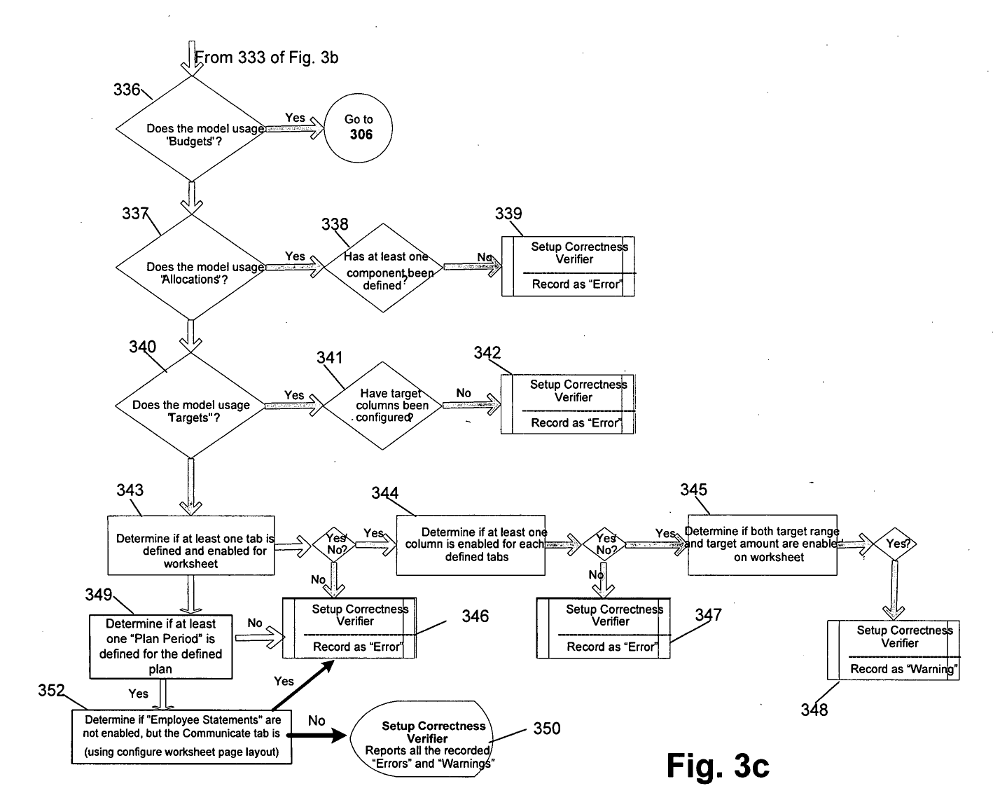

FIGS. 3a-3c are a flow diagram of the functionality of compensation module 16 when validating setup parameters for a compensation system in accordance with one embodiment. In one embodiment, the functionality of the flow diagram of FIGS. 3a-3c is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 302, it is determined if a plan is defined in which compensation will be awarded. In one embodiment, a plan that awards compensation can be defined as a compensation only plan that allows managers to reward employees (e.g. Salary Change, Bonus and Stock Options), a compensation+performance plan that allows managers to not only reward employees but also do the performance evaluations, or a compensation+performance+job change (promote) plan that allows managers to reward employees, do the performance evaluation and make recommendation for job change.

If yes at 302, at 303 it is determined if at least one component is defined. In one embodiment, a component can be a further breakdown to a larger compensation amount. For example, a salary increase may have components of a cost of living adjustment, employee merit adjustment and a company performance adjustment. Further, a component may make up portions of a total compensation. For example, one component could be for a bonus, and another could be for stock options. In this example, a manager may award an employee both within a single plan and on a single worksheet. A bonus plan may include components such as individual performance or company performance. A salary plan may include components such as cost of living and market adjustment. Therefore, components can be used to further classify a reward into different sub-parts. If no at 302, an error is recorded at 304.

At 306, it is determined if budgeting is enabled. If yes, at 307 it is determined if a budget pool is created. If no at 307, a warning is recorded at 314. If yes at 307, at 308 it is determined if a primary component is defined. If not, an error is recorded at 310. Further, if yes at 307, it is determined if “percent” is used as a budgeting style at 309. If yes, at 311 it is determined if the primary components of the pool have eligible salary component configured, and at 312 it is determined if the % of eligible salary is shown or configured—if yes then that component should have a eligible salary component configured. If no at 311 or 312, an error is recorded at 313. Further, if yes at 307, at 315 it is determined if the budget pool is getting used by an component. If no at 315, at 316 a warning is recorded.

At 320, it is determined if a salary plan without components is defined. If yes, at 321 it is determined if only one column is marked for salary posting. If no at 321, an error is recorded at 322.

At 323 it is determined if a performance module has been enabled. If yes, at 324 it is determined if a performance effective date has been defined. If no at 324, an error is recorded at 326.

At 327, it is determined if any modeling actions are enabled. If yes, at 328 it is determined if modeling is enabled for the plan. If no at 328, at 329 an error is recorded.

At 330, it is determined if audit history action is enabled. If yes at 331, it is determined if at least one column is marked as enable audit”. If no at 331, at 332 an error is recorded.

At 333, it is determined if custom segments have been enabled as modeling or analytics dimensions. If no at 333, at 334 it is determined if column properties have been defined for custom segments. If no at 334, an error is recorded.

At 336, it is determined if the model usage is “budgets”. If yes, functionality resumes at 306.

At 337, it is determined if the model usage is “allocations”. If yes, at 338 it is determined if at least one component has been defined. If no, an error is recorded at 339.

At 340, it is determined if the model usage is “targets”. If yes, at 341 it is determined if target columns have been configured. If no, an error is recorded at 342.

At 343, it is determined if at least one tab is defined and enabled for the worksheet. If no, an error is recorded at 346. If yes at 343, at 344 it is determined if at least one column is enabled for each defined tabs. If no, an error is recorded at 347. If yes at 344, at 345 it is determined if both target range and target amount are enabled. If yes, a warning is recorded at 348.

At 349, it is determined if at least one “plan period” is defined for the defined plan. If no, an error is recorded at 347.

At 352, it is determined if “Employee Statements” are not enabled, but the “Communicate” tab is (using configure worksheet page layout). If yes, an error is recorded at 347. In one embodiment, the “Employee Statements” provide a way for managers to communicate “Compensation Change(s)” to employees using “Compensation Change Letter/Statements”. A Compensation Administrator/Consultant first defines a Rich Text Format (“RTF”) or PDF template by making use of supported compensation attributes (e.g., Salary Amount, Bonus Amount, Employee Details, etc.). An RTF template can be defined using any editor that supports RTF (e.g., Microsoft Word). A defined template is then attached to a Compensation Plan (e.g., Global Salary Change Plan—2008) using a user interface (e.g., Enabling “Employee Statement”) so that managers can make use of this template to generate “Employee Compensation Statement” for employees using a “Communicate” tab on the compensation system user interface.

Finally at 350, all recorded errors and warnings are reported to the administrator via a user interface.

The functionality of FIGS. 3a-3c allow errors or oversights to be detected prior to a setup routine that creates transaction data. For example, a recursive reporting hierarchy structure may have been defined by an administrator so that, for example, A→B→C→A. This relatively common setup mistake will be flagged by the functionality of FIGS. 3a-3c before causing a transactional error.

Another example is an error of assigning the same element to different rates, which could be of different types, or errors in dynamic calculation definitions. Dynamic calculations in one embodiment provide a faster approach towards showing some pre-calculated information to the user on screen or calculated information, which is computed on the fly. This is additional information provided to the manager to help in his/her decision making process. The dynamic calculation is defined during setup creation and any wrong entry in it can result is either inaccurate information displayed to the manager or information which is not intelligible at all. Dynamic calculations allow a flexible configuration of the worksheet. Dynamic calculations are defined during setup, and the result of these are evident when the manager is using the worksheet. For example, a manager may rate an employee “Above Average” on the worksheet, and as a result, a dynamic calculation executes and calculates the contents of a “Target Bonus Amount” column, based on the entered performance rating, and perhaps the employee's job and location. Dynamic calculations allow a user to automatically derive the value of one column upon the entry/update of another column,

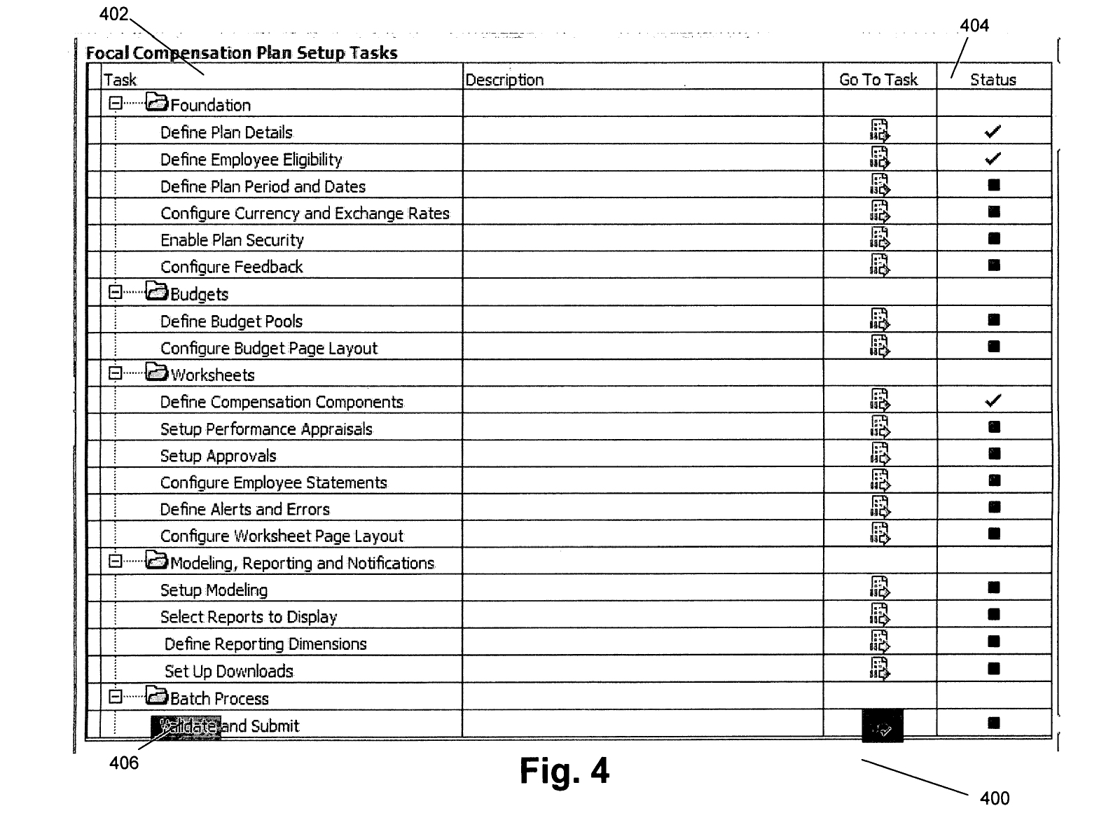

FIG. 4 is a user interface (“UI”) 400 for tracking that setup tasks are completed and initiating validation in accordance with one embodiment. UI 400 includes a task column 402 that lists all of the setup tasks, and a status column 404 that provides the status of all setup tasks (e.g., completed, partially completed, etc.). In one embodiment, a box in column 402 means “not started” and a check means “completed”. After finishing the setup tasks, an administrator can choose to validate and run the process so that setup can be executed by selecting the validate and submit task link 406.

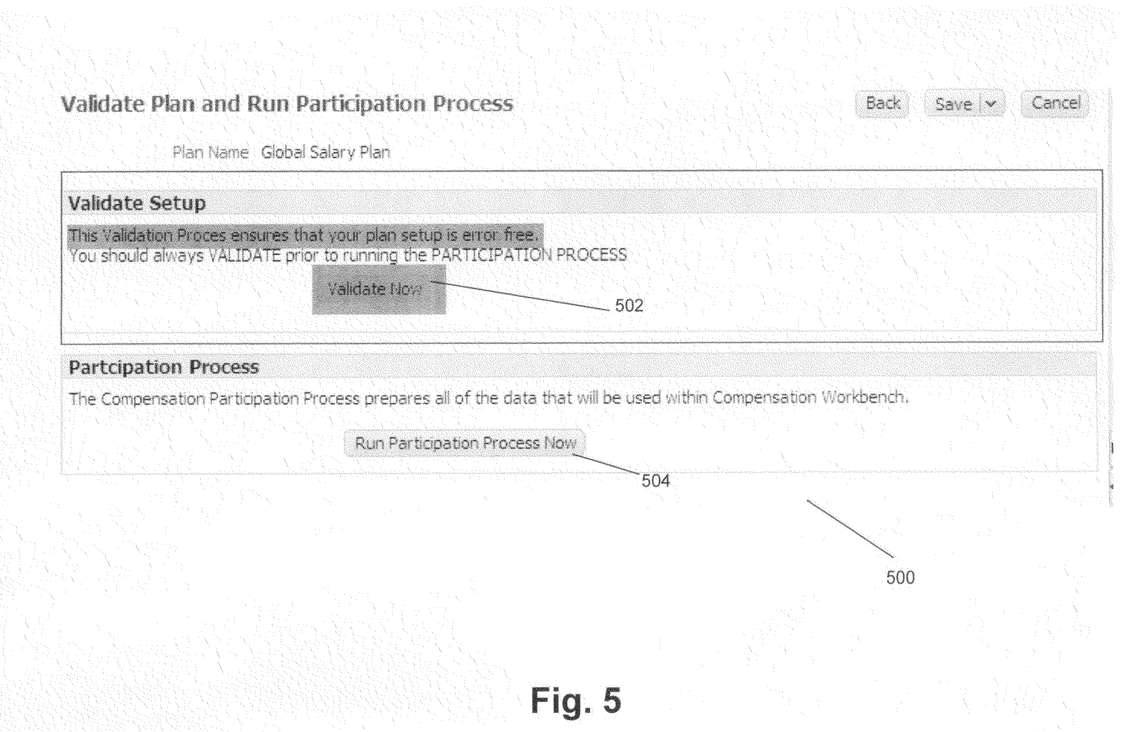

FIG. 5 is a UI 500 in accordance with one embodiment that allows an administrator to check setup for readiness in response to selecting task 406 of FIG. 4. The administrator can select validate now button 502 before committing to changes in the system. Therefore, errors and warnings will be provided to the user before initiating the participation process with button 504.

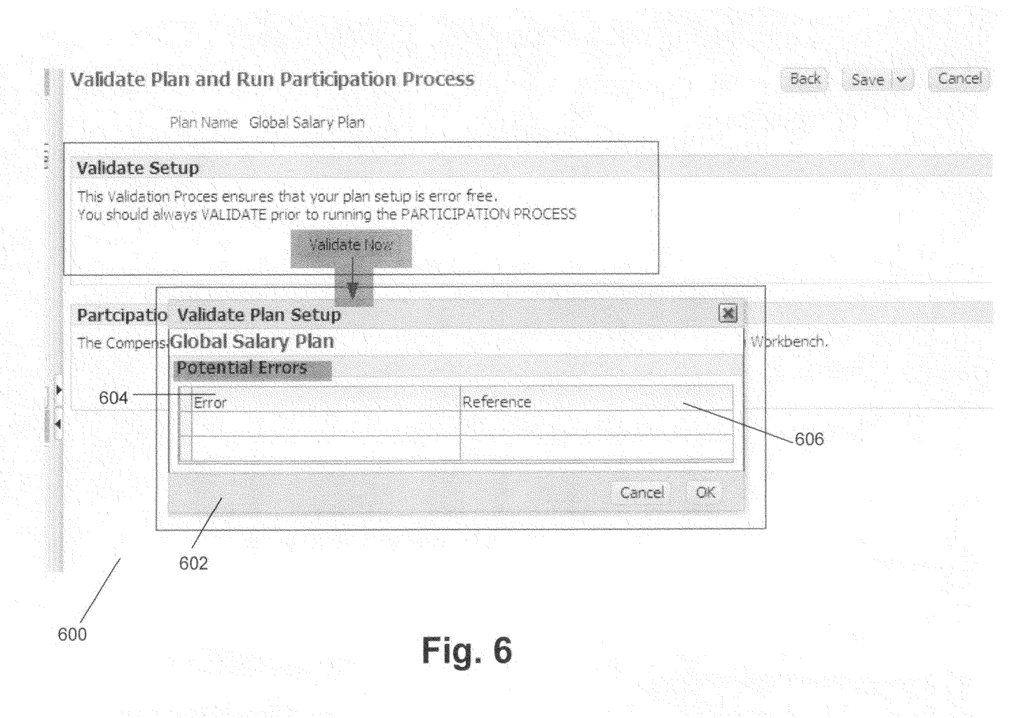

In response to selecting button 502 of FIG. 5, a window pops up in one embodiment that reports potential errors and warnings. FIG. 6 is a UI 600 in accordance with one embodiment that illustrates pop up window 602. Window 602 includes a list of potential errors at column 604 and a list of references and tips to resolve the errors at column 606.

As disclosed, embodiments include a compensation system that provides verification that all setup parameters were correctly entered before a setup procedure is run. The compensation system can then be implemented with a minimized risk of errors.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A method of operating a compensation system, the method comprising:
receiving a plurality of setup parameters; and
testing the setup parameters through a verification;
wherein the verification generates an error output if the setup parameters will lead to undesirable results when operating the compensation system.

2. The method of claim 1, wherein the verification generates a warning output if the setup parameters may lead to undesirable results when operating the compensation system.

3. The method of claim 1, wherein the setup parameters comprise at least one of: define employee eligibility; define plan periods and dates; configure currency and exchange rates; and enable plan security.

4. The method of claim 1, wherein the setup parameters comprise at least one of: define budget pools; and configure budget page layout.

5. The method of claim 1, wherein the setup parameters comprise at least one of: define compensation components; setup performance appraisals; setup approvals; configure employee statements; and define alerts.

6. The method of claim 1, wherein the setup parameters comprise at least one of: setup modeling; setup analytical reports; and setup downloads.

7. The method of claim 1, further comprising:
generating a first user interface that displays a list of setup tasks and a status of the list, the first user interface comprising a link to initiate the verification.

8. The method of claim 1, wherein the setup parameters will lead to undesirable results due to a recursive reporting hierarchy structure.

9. The method of claim 1, wherein the setup parameters will lead to undesirable results due to assigning a same element to different rates.

10. A computer readable media having instructions stored thereon that, when executed by a processor, causes the processor to function as a compensation system, the instructions comprising:
logic for receiving a plurality of setup parameters; and
logic for testing the setup parameters through a verification;
wherein the verification generates an error output if the setup parameters will lead to undesirable results when operating the compensation system.

11. The computer readable media of claim 10, wherein the verification generates a warning output if the setup parameters may lead to undesirable results when operating the compensation system.

12. A compensation system comprising:
means for receiving a plurality of setup parameters; and
means for testing the setup parameters through a verification;
wherein the verification generates an error output if the setup parameters will lead to undesirable results when operating the compensation system.

13. The compensation system of claim 12, wherein the verification generates a warning output if the setup parameters may lead to undesirable results when operating the compensation system.

14. A method of verifying a setup for a compensation system, the method comprising:
receiving setup parameters;
validating the setup parameters by determining if the setup parameters will lead to an error when operating the compensation system;
wherein the error comprises at least one of: a recursive hierarchy structure; an assignment of a same element to different rates; and a dynamic calculation definition error.
